(19) United States
(12) Patent Application Publication
(10) Pub. No.: US 2003/0211847 A1
(43) Pub. Date: Nov. 13, 2003

(54) Managing transition of a mobile station to an idle state upon call release

(75) Inventors: Ke-Chi Jang, Plano, TX (US); Chung-Ching Wang, Plano, TX (US)

Correspondence Address: TROP PRUNER & HU, PC, 8554 KATY FREEWAY, SUITE 100, HOUSTON, TX, 77024, US

(73) Assignee: Nortel Networks Limited, St. Laurent (CA)

(21) Appl. No.: 10/324,521

(22) Filed: Dec. 19, 2002

Related U.S. Application Data
(60) Provisional application No. 60/379,189, filed on May 9, 2002.

(51) Int. Cl. H04Q 7/20

(52) U.S. Cl. 455/434; 455/450

(57) ABSTRACT

A mobile communications network includes base stations that send messages to mobile stations to control whether the mobile stations transitions to an initialization state or idle state upon call release. The messages also optionally contain frequency and other call control information for the mobile station to use for a subsequent communications session.

### CROSS REFERENCE TO RELATED APPLICATION

This claims the benefit under 35 U.S.C. § 119(e) of U.S. Provisional Application Serial No. 60/379,189, entitled “Method for Base Station Managing the Mobile Station's Traffic-to-Idle Transition,” filed May 9, 2002, which is hereby incorporated by reference.

### TECHNICAL FIELD

The invention is generally related to managing the transition by a mobile station to an idle state.

### BACKGROUND

Mobile communications systems, such as cellular or personal communications services (PCS) systems, are made up of a plurality of cells. Each cell provides a radio communication center in which a mobile station establishes a call with another mobile station or a wireline unit connected to a public switched telephone network (PSTN) or a packet data network. Each cell includes a radio base station, with each base station connected to a mobile switching center that controls processing of calls between or among mobile stations or mobile stations and wireline terminals.

Various wireless protocols exist for defining communications in a wireless network. One such protocol is the time-division multiple access (TDMA) standard. According to TDMA, each radio frequency (RF) carrier carries a frame that is divided into plural (e.g., six or eight) times slots to increase the number of mobile stations that can be supported per RF carrier.

Another standard for wireless communications is the code-division multiple access (CDMA) standard. CDMA is a spread spectrum wireless communications protocol in which transmission is based on the spread spectrum modulation technique to allow many users to have access to the same band of carriers.

Traditionally, wireless networks have been designed for carrying circuit-switched voice traffic. However, with the explosion of the Internet and intranets, packet-switched communications (e.g., web browsing, electronic mail, and so forth) have become common. As a result, third generation (3G) wireless technologies are being developed to transition to higher bandwidth and more efficient packet-switched communications (of data as well as voice and other forms of real-time data) over wireless networks.

To achieve 3G requirements, the CDMA 2000 family of standards has been developed, also referred to as the IS-2000 Standard. A CDMA 2000 wireless communications system is capable of supporting both traditional voice traffic as well as packet-switched traffic, such as web browsing, electronic mail, voice-over-IP (Internet Protocol), and so forth. On the TDMA side, packet-switched wireless communications protocols have also been developed.

The IS-2000 standard defines various states for the mobile station, including, for example, the Mobile Station Initialization State, Mobile Station Idle State, the System Access State, and the Mobile Station Control on the Traffic Channel State. Release A of IS-2000 specified that the mobile station had to transition back to the Mobile Station Initialization State upon call release (termination of a call). In the Mobile Station Initialization State, the mobile station selects a system (i.e., a wireless communications network), acquires a pilot channel, obtains systems configuration and timing information, and synchronizes the mobile station timing to the wireless communications network. Once it has performed all these tasks, the mobile station transitions to the Mobile Station Idle State, where the mobile station is ready to initiate or receive a call.

For traditional circuit-switched communications, the transition of the mobile station back to the Mobile Station Initialization State is an acceptable solution. However, for packet-switched communications, in which data is typically sent as a series of numerous bursts, the transition back to the Mobile Station Initialization State upon call release is inefficient, because the mobile station must perform all the tasks required in the Initialization State upon each call release at the end of each burst. If the mobile station has to transition back to the Initialization State at the end of each of those bursts, then the mobile station would have to spend a relatively large amount of time performing initialization tasks.

To address this issue, Release B of IS-2000 (IS-2000-B) added a feature in which the mobile station can transition to the Mobile Station Idle State upon call release. By transitioning directly to the Idle State (and bypassing the Initialization State), the mobile station can achieve faster transition from a dormant state (the idle state) to an active state.

However, even though this feature of IS-2000-B enables more efficient operations at the mobile station, the lack of control by base stations in the wireless communications network in determining whether a mobile station is to transition back to the Mobile Station Initialization State or the Mobile Station Idle State means that it is difficult for the base stations to perform traffic balance management. A further issue is that upon transitioning back to the Idle State, the mobile station stores prior call control information (such as the frequency of the carrier, the paging channel information, and so forth) for use in a subsequent call. However, the stored call control information may become stale and thus may no longer be valid for use in a subsequent call, which may result in a base station being unable to successfully page the mobile station.

### SUMMARY

In general, methods and apparatus are provided to enable a wireless communications network to control the transition of mobile station to a dormant state (such as an initialization state or an idle state). For example, a method for wireless communications includes receiving, by a mobile station, an indicator in a message from a base station, the indicator having at least a first state and a second state. Upon call release, the mobile station transitions to an initialization state if the indicator is at the first state, and the mobile station transitions to an idle state if the indicator is at the second state.

Other or alternative features will become apparent from the following description, from the drawings, and from the claims.

### BRIEF DESCRIPTION OF THE DRAWINGS

FIG. 1 is a block diagram of an example arrangement of a wireless communications network.

FIG. 2 is a flow diagram of a process according to one embodiment of controlling the transition of mobile stations to a dormant state.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

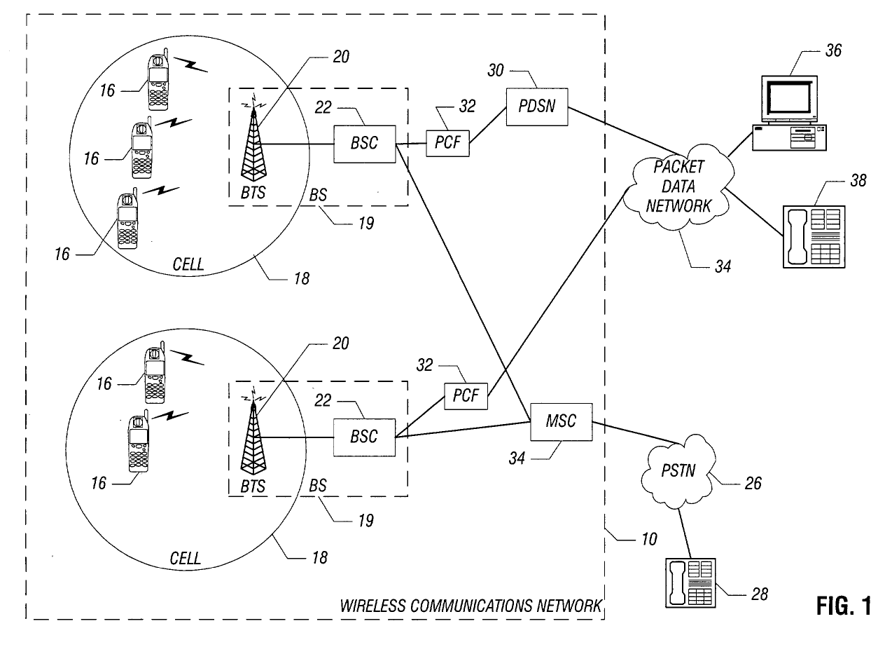

Referring to FIG. 1, a wireless communications network 10 according to one embodiment includes components that operate according to CDMA (code-divisional multiple access) 2000. CDMA 2000 is defined by the CDMA 2000 family of standards (collectively referred to as the IS-2000 Standard), which is developed by the Third Generation Partnership Project 2 (3GPP2). However, in other embodiments, other types of wireless protocols can be used for communications in the wireless communications network 10, including other versions of CDMA, TDMA protocols, and other protocols.

The wireless communications network 10 includes multiple cells 18, each including a base transceiver subsystem (BTS) 20 for performing radio telecommunications with mobile stations within the coverage area of the cell 18. The BTS entities 20 are connected to one or more base station controllers (BSCs) 22. Collectively, a BTS 20 and BSC 22 is referred to as a “base station” 19. More generally, a “base station” refers to any entity (or collection of entities) that communicates wirelessly with mobile stations and that exchange control signaling with the mobile stations for establishing, terminating, or otherwise managing communication sessions (e.g., circuit-switched call sessions, packet-switched voice call sessions, other packet-switched communications sessions, and so forth).

For communicating circuit-switched voice traffic., the BSC 22 is coupled to a mobile switching center (MSC) 24, which is responsible for switching mobile station-originated or mobile station-terminated traffic. Effectively, the MSC 24 is the interface for signaling and user traffic between the wireless network 10 and other public switched networks (such as a public switched telephone network (PSTN) 26) or other MSCs. The PSTN 26 is connected to landline terminals, such as telephones 28.

In a voice call session between a mobile station (such as mobile station 16) and a landline terminal (such as telephone 28), voice traffic is routed through the air interface between the mobile station 16 and a base station 14, and through the base station 14, MSC 24, and PSTN 26.

The wireless communications network 10 also supports packet data services, in which packet data is communicated between a mobile station and another endpoint, which can be a terminal coupled to a packet data network 34 or another mobile station that is capable of communicating packet data. Examples of the packet data network 34 include private networks (such as local area networks or wide area networks) and public networks (such as the Internet). Packet data is communicated in a packet-switched communications session established between the mobile station and the other endpoint.

To communicate packet data, the BSC 22 is coupled to a packet control function (PCF) module 32, which manages the relay of packets between the BSC 22 and a packet data serving node (PDSN) 30. The BSC 22 and PCF module 32 can be implemented on one platform or on multiple platforms.

The PDSN 30 establishes, maintains, and terminates link layer sessions to mobile stations, and routes mobile station-originated or mobile station-terminated packet data traffic. The PDSN 30 is coupled to the packet data network 34, which is connected to various endpoints, such as a computer 36 or a network telephone 38 (which is a telephone that is fitted with a network interface card for communications over packet data networks). Examples of packet-switched communications include web browsing, electronic mail, text chat sessions, file transfers, interactive game sessions, voice-over-IP (Internet Protocol) sessions, and so forth.

The wireless communications network 10 thus provides two different types of communications: circuit-switched communications and packet-switched communications. Circuit-switched communications are routed through the MSC 24, while packet-switched communications are routed through the PDSN 30. In circuit-switched communications, a dedicated end-to-end channel is established for the duration of a call session. However, packet-switched communications utilize a connectionless intranetwork layer, such as that defined by the Internet Protocol (IP). In packet-switched communications, packets or other units of data carry routing information (in the form of network addresses) that is used to route the packets or data units over one or more paths to a destination endpoint.

One version of IP, referred to as IPv4, is described in Request for Comments (RFC) 791, entitled “Internet Protocol,” dated September 1981; and another version of IP, referred to as IPv6, is described in RFC 2460, “Internet Protocol, Version 6 (IPv6) Specification,” dated December 1998.

Each mobile station 16 in the wireless communications network 10 has multiple states. As defined by IS-2000, the states include the Mobile Station Initialization State, the Mobile Station Idle State, the System Access State, and the Mobile Station Control on the Traffic Channel State. In the Mobile Station Initialization State, the mobile station selects and acquires a system, which in this case is the wireless communications network 10. In the Mobile Station Idle State, the mobile station is ready to initiate or receive calls. In the System Access State, the mobile station sends messages to the base station and receives messages from the base station to initiate a call. In the Mobile Station Control on the Traffic Channel State, the mobile station communicates data (either voice data or packet data) over traffic channels.

According to IS-2000, the Mobile Station Initialization State itself has several sub-states, including a System Determination Sub-State (in which the mobile selects which system to use), a Pilot Channel Acquisition Sub-State (in which the mobile station acquires the pilot channel of the wireless communications network), a Sync Channel Acquisition Sub-State (in which the mobile station obtains system configuration and timing information for the wireless communications network), and the Timing Change Sub-State (in which the mobile station synchronizes its timing to that of the wireless communications network).

For more efficient packet-switched communications of the mobile stations 16, it is desirable to have the mobile stations transition to the Mobile Station Idle State upon call release, instead of transitioning back to the Initialization State. By transitioning to the Idle State, the mobile station can more quickly transition back to an active state to establish a new call. However, for improved performance of the wireless communications network, in accordance with some embodiments of the invention, the wireless communications network 10 is able to control and manage whether or not the mobile stations 16 transition back to the Mobile Station Idle State upon call release (or whether the mobile stations 16 transition back to the Mobile Station Initialization State upon call release). As used here, “call release” refers to termination of a communications session (whether packet-switched or circuit-switched). A “call” refers to a packet-switched or circuit-switched communications session.

In some embodiments, the control and management of whether the mobile station transitions to the initialization state or idle state is achieved by the base station sending a broadcast message to all mobile stations 16 within its cell 18. This broadcast message includes a dormant state indicator for indicating whether the transition to the Idle State is to be enabled or not. The broadcast message also includes various call control information, such as the carrier frequency to use, the paging channel (PCH) information, the broadcast control channel (BCCH) information, timing information, and so forth. Thus, in accordance with some embodiments of the invention, a base station 19 is able to select (by setting the dormant state indicator to one of plural states) whether the mobile stations are to return to the Idle State or the Initialization State upon call release. Further, if the base station sets the dormant state indicator to a value for causing the mobile stations 16 to transition to the Idle State upon call release, the base station optionally sends additional information for the mobile station to use in a subsequent call so that the call control information stored in the mobile station does not become stale. In other words, by updating the call control information in the mobile station, a base station 19 can successfully page the mobile station in a subsequent access.

In accordance with one embodiment, the dormant state indicator is referred to as RETURN_TO_IDLE_INDᵣ, which is provided in one or more broadcast messages from the base station 19 to mobile stations 16 within a given cell 18. The indicator RETURN_TO_IDLE_INDᵣ has one of two values: ‘0’ means that the mobile station is to return to the System Determination Sub-State of the Mobile Station Initialization State upon call release; and ‘1’ means that the mobile station is enabled to transition to the Mobile Station Idle State if certain conditions are satisfied. In one embodiment, the RETURN_TO_IDLE_INDᵣ indicator is a single-bit parameter that is set to either the low or high state. In other embodiments, multi-bit parameters can be used for indicating whether to transition to the Mobile Station Initialization State or Idle State.

In the IS-2000 system, two broadcast messages are available: Extended System Parameters Message, which is broadcast by the base station to the mobile station in the paging channel (PCH); and MC-RR Parameters Message, which is broadcast by the base station to the mobile stations in the broadcast control channel (BCCH). The specific messages referred to here apply to the IS-2000 system. Note that in alternative embodiments, other types of messages can be employed for communicating the dormant state indicator and call control information to the mobile stations. Also note that the Mobile Station Initialization State and Mobile Station Idle State refer to one implementation in the IS-2000 wireless communications network. In other embodiments that employ other types of wireless technologies, other states of the mobile station are defined.

More generally, an “initialization state” refers to a state in which a mobile station has to acquire certain control channels and control information to enable it to communicate with the wireless communications network; and an “idle state” refers to a state of the mobile station in which the mobile station has acquired the necessary control channels and control information and is in a state in which the mobile station is ready to originate or receive a call. Thus, generally, the base station of the wireless communications network 10 is able to send a message to one or more mobile stations to control whether the mobile station is to transition to an idle state or an initialization state upon call release.

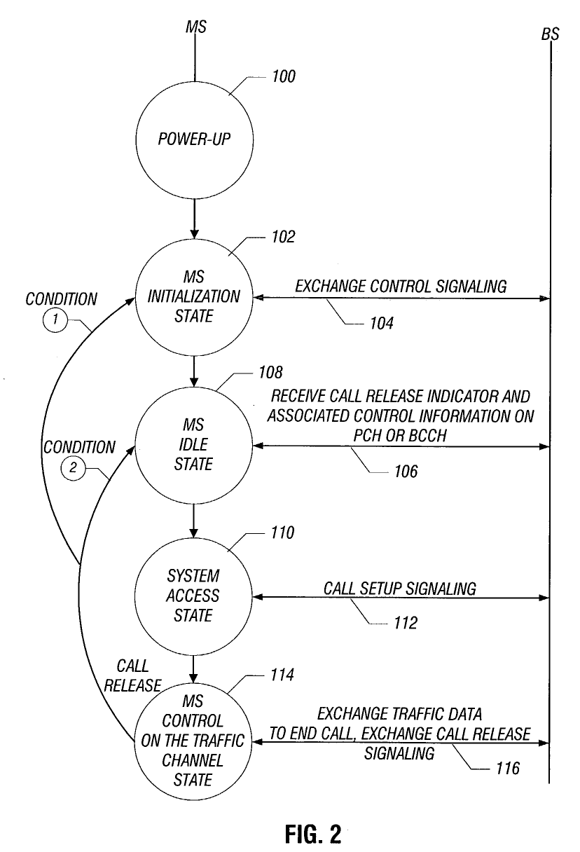

FIG. 2 is a message flow diagram that illustrates the various states of the mobile station as well as signaling exchange between a mobile station and a base station. Upon powering up (at 100), the mobile station enters the Mobile Station Initialization State (at 102). In this state, the mobile station selects the wireless communications network system to use as well as acquires a paging channel (PCH) or a broadcast control channel (BCCH), obtains system configuration and timing information, and synchronizes timing to the base station. This is accomplished by exchanging control signaling (at 104) between the mobile station and the base station.

Next, after the mobile station has acquired the necessary control information and performed the necessary timing synchronization, the mobile station enters the Mobile Station Idle State (at 108). In this state, the mobile station is able to originate or receive a call to start a call session. Also, starting in this state, the mobile station is able to receive the broadcast messages mentioned above, including the Extended System Parameter Message on the paging channel (PCH) or the MC-RR Parameters Message on the broadcast control channel (BCCH). In these broadcast messages, the mobile station receives (at 106) the dormant state indicator (to indicate whether to transition back to the initialization state or idle state upon call release) and associated control information. Note that the broadcast messages are sent on a periodic basis. Such messages are also received by the mobile station when it is in other states, including the System Access State (at 110) and the Mobile Station Control on the Traffic Channel State (at 114). Therefore, the mobile station continually receives the dormant state indicator and associated control information.

To set up a call, the mobile station enters the System Access State (at 110), and exchanges call setup signaling (at 112) with the base station. Once the call has been set up, the mobile station transitions to the Mobile Station Control on the Traffic Channel State (at 114), where the mobile station exchanges traffic data and other control signaling (at 116) with the base station. To end the call, call release signaling is exchanged between the mobile station and base station.

Upon call release, the mobile station transitions from state 114 to one of the Mobile Station Initialization State and Mobile Station Idle State, depending on the state of the dormant state indicator and the values of associated control information. If the state of the indicator RETURN_TO_IDLE_INDᵣ is at a low state (‘0’), then the mobile station transitions back to the Mobile Station Initialization State (at 102). However, if the indicator RETURN_TO_IDL_INDᵣ has a high value (‘1’), then the mobile station transitions to the Mobile Station Idle State (at 108), provided that certain conditions are met based on control information sent from the base station to the mobile station in the broadcast messages.

The following are the fields contained in the Extend System Parameters Message:

TABLE 1

Field
[...]
RETURN_TO_IDLE_IND
FREQ_INCL
BAND_CLASS
CDMA_FREQ
RETURN_TO_CH_TYPE
PAGE_CHAN
PRAT
SR1_BCCH_CODE_CHAN
SR3_BCCH_CODE_CHAN
BRAT
CART
FOR_PDCH_INCL

As noted above, the base station sets the RETURN_TO_IDLE_IND indicator to ‘1’ if the mobile station is allowed to return to the Idle State upon call release; otherwise, the base station sets this indicator to ‘0’.

FREQ_INCL is the frequency included indicator. If RETURN_TO_IDLE_IND is set to ‘0’, the base station omits this field; otherwise, the base station sets this field as follows: If the BAND_CLASS and CDMA_FREQ fields are included in this assignment record, the base station sets FREQ_INCL to ‘1’. However, if the CDMA_FREQ field is not included in this assignment record, the base station sets FREQ_INCL to ‘0’.

BAND_CLASS is a band class indicator. If the FREQ_INCL bit is set to ‘1’, the base station sets this field to the CDMA band class corresponding to the CDMA frequency assignment for the CDMA channel containing the forward traffic channel the mobile station is to use. If the FREQ_INCL bit is set to ‘0’, the base station omits this field. CDMA_FREQ is a frequency assignment field. If the FREQ_INCL bit is set to ‘1’, the base station sets this field to the CDMA channel number corresponding to the CDMA frequency assignment for the CDMA channel containing the forward traffic channel the mobile station is to use. If the FREQ_INCL bit is set to ‘0’, the base station omits this field.

RETURN_TO_CH_TYPE is a return to idle channel type field. If RETURN_TO_IDLE_IND is set to ‘0’, the base station omits this field; otherwise, the base station sets this field to one of plural values to indicate whether the mobile station is to return to a paging channel (PCH) or a BCCH (and if so, which type of BCCH).

PAGE_CHAN is a paging Channel number field. If RETURN_TO_CH_TYPE is set to a first value, the base station sets this field to the paging channel (PCH) number on which the mobile station is to idle on; otherwise, the base station omits this field. PRAT is the paging channel data rate field. If RETURN_TO_CH_TYPE is set to the first value, the base station sets this field to a predetermined value corresponding to the data rate used by the paging channels in the system; otherwise, the base station omits this field.

SR1_BCCH_CODE_CHAN is a Spreading Rate 1 BCCH Walsh code field. If RETURN_TO_CH_TYPE is set to a second value, the base station sets this field to the Walsh code corresponding to the Spreading Rate 1 BCCH in non-transmit diversity mode. However, if RETURN_TO_CH_TYPE is set to a third value, the base station sets this field to the Walsh code corresponding to the spreading rate 1 BCCH in transmit diversity mode. Otherwise, the base station omits this field.

SR3_BCCH_CODE_CHAN is a Spreading Rate 3 BCCH Walsh code field. If RETURN_TO_CH_TYPE is set to a fourth value, the base station sets this field to the Walsh code corresponding to the Spreading Rate 3 BCCH; otherwise, the base station omits this field.

The BRAT field indicates the BCCH data rate. If RETURN_TO_CH_TYPE is set to one of the first, second, and third values, the base station sets this field to a value corresponding to the data rate used by the primary BCCH in the system; otherwise, the base station omits this field.

The CRAT field indicates the BCCH code rate. If RETURN_TO_CH_TYPE is set to one of the second and third values, the base station sets this field to ‘0’ if the BCCH code rate is ¼. The base station sets this field to ‘1’ if the BCCH code rate is ½. If RETURN_TO_CH_TYPE is set to the third value, the base station sets this field to ‘0’. Otherwise, the base station omits this field.

Note that the various fields listed are provided by way of example only. In other embodiments, many of the messages in the Extended System Parameters Message can be omitted. Also, note that other fields may also be present in the Extended System Parameters Message.

In another implementation, instead of the Extended System Parameters Message, the MC-RR Parameters Message is used instead to communicate the fields discussed above, along with other fields.

The mobile station stores various parameters (set to the values of various fields in the Extended System Parameters Message or the MC-RR Parameters Message) during the idle state so that the mobile station is able to establish a call with a base station. As noted above, if the broadcast message from the base station contains RETURN_TO_IDLE_INDᵣ set to ‘0’, then the mobile station returns to the Mobile Station Initialization State. However, if RETURN_TO_IDLE_INDᵣ is equal to ‘1’, the mobile station stores the following parameters set to the indicated values:

(1) If FREQ_INCLᵣ equals to ‘1’, the mobile station sets IDLE_CDMABAND to BAND_CLASSᵣ and IDLE_CDMACH to CDMA_FREQᵣ. The “r” subscript indicates that the field is received from the base station in a message. The stored version of the field is represented with an “s” subscript. IDLE_CDMACH indicates the CDMA carrier frequency that the mobile station is assigned, while IDLE_CDMABAND indicates the CDMA band class the mobile station is assigned.

(2) If RETURN_TO_CH_TYPEᵣ equals to the first value, the mobile station sets IDLE_PAGE_CHAN to PAGE_CHANᵣ and IDLE_PRAT to PRATᵣ. IDLE_PAGE_CHAN indicates the paging channel (PCH) that the mobile station is to receive pages on, and IDLE_PRAT indicates the paging channel data rate.

(3) If RETURN_TO_CH_TYPEᵣ equals to the second and third values, the mobile station sets IDLE_BCCH to SR1_BCCH_CODE_CHANᵣ, where IDLE_BCCH indicates the BCCH assigned to the mobile station.

(4) If RETURN_TO_CH_TYPEᵣ equals the fourth value, the mobile station sets IDLE_BCCH to SR3_BCCH_CODE_CHANᵣ.

(5) If RETURN_TO_CH_TYPEᵣ equals the second, third, and fourth values, the mobile station sets IDLE_BRAT to BRATᵣ, and IDLE_BCCH_CODE_RATE to CRATᵣ.

When return to idle state upon call release is enabled (i.e., the dormant state indicator is set to a predetermined value), the mobile station stores the PCH information (paging channel and data rate) if the RETURN_TO_CH_TYPE field stored in the mobile station indicates a return to the PCH. However, if the stored RETURN_TO_CH_TYPE field is assigned a value indicating a return to one of the BCCHs, then the mobile station stores the BCCH information discussed above upon entering the Idle State.

However, if the RETURN_TO_CH_TYPE field is not set to any one of the first, second, third, and fourth values mentioned above, then the default procedure provided by Release B of IS-2000 is used to return to the Mobile Station Idle State.

A system has been described that allows the base station to control whether mobile stations within a given cell is allowed to transition back to an initialization state or to an idle state upon call release. Also, a protocol is defined that allows the base station to communicate control information such that when the mobile station transitions to the idle state upon call release, the control information that the mobile station stores to enable it to participate in a subsequent call session is updated information, not stale information.

Instructions of the various software routines or modules discussed herein (such as the base station 19 or mobile station) are stored on one or more storage devices in the corresponding systems and loaded for execution on corresponding control units or processors. The control units or processors include microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the various software modules and layers) are stored in respective storage units, which can be implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software modules or layers are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers. In the loading or transport process, data signals that are embodied in carrier waves (transmitted over telephone lines, network lines, wireless links, cables, and the like) communicate the code segments, including instructions, to the device or system. Such carrier waves are in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of wireless communications, comprising:
receiving, by a mobile station, an indicator in a message from a base station, the indicator having at least a first state and a second state; and
upon call release, the mobile station transitioning to an initialization state if the indicator is at the first state, and the mobile station transitioning to an idle state if the indicator is at the second state.

2. The method of claim 1, wherein receiving the indicator in the message comprises receiving the indicator in a broadcast message.

3. The method of claim 1, wherein receiving the indicator in the message comprises receiving the indicator in an IS-2000 Extended System Parameters Message.

4. The method of claim 1, wherein receiving the indicator in the message comprises receiving the indicator in an IS-2000 MC-RR Parameters Message.

5. The method of claim 1, further comprising receiving call control information in the message.

6. The method of claim 5, wherein receiving the call control information comprises receiving carrier frequency information in the message.

7. The method of claim 5, wherein receiving the call control information comprises receiving a code-division multiple access (CDMA) band class.

8. The method of claim 5, wherein receiving the call control information comprises receiving an indication of one of a paging channel and broadcast control channel to return to in the idle state.

9. The method of claim 5, wherein receiving the call control information comprises receiving one or more of a paging channel number and a paging channel data rate.

10. The method of claim 5, wherein receiving the call control information comprises receiving one or more of a broadcast control channel Walsh code, a broadcast control channel data rate, and a broadcast control channel code rate.

11. The method of claim 5, further comprising storing, by the mobile station, the call control information.

12. The method of claim 1, wherein transitioning to the initialization state comprises transitioning to an IS-2000 Mobile Station Initialization State, and wherein transitioning to the idle state comprises transitioning to an IS-2000 Mobile Station Idle State.

13. The method of claim 1, further comprising establishing a packet-switched call between the mobile station and base station.

14. The method of claim 1, wherein the mobile station transitions to the idle state in response to the indicator being at the second state and at least one other condition being satisfied.

15. An article comprising at least one storage medium containing instructions that when executed cause a mobile station to:
receive an indicator in a message from a base station, the indicator having at least a first state and a second state, and
transition to an initialization state, upon call release, if the indicator is at the first state; and
transition to an idle state, upon call release, if the indicator is at the second state.

16. The article of claim 15, wherein receiving the indicator in the message comprises receiving the indicator in a broadcast message.

17. The article of claim 15, wherein the instructions when executed further cause the mobile station to receive call control information in the message.

18. The article of claim 17, wherein receiving the call control information comprises receiving carrier frequency information.

19. The article of claim 17, wherein receiving the call control information comprises receiving a code-division multiple access (CDMA) band class.

20. The article of claim 17, wherein receiving the call control information comprises receiving an indication of one of a paging channel and broadcast control channel to return to in the idle state.

21. The article of claim 17, wherein receiving the call control information comprises receiving one or more of a paging channel number and a paging channel data rate.

22. The article of claim 17, wherein receiving the call control information comprises receiving one or more of a broadcast control channel Walsh code, a broadcast control channel data rate, and a broadcast control channel code rate.

23. The article of claim 17, further comprising storing, by the mobile station, the call control information.

24. A base station comprising:
an interface to communicate with a mobile station; and
a controller to transmit, in a message, an indicator to the mobile station,
the indicator having at least a first state and a second state,
the indicator at a first state indicating a transition of the mobile station to an initialization state upon call release, and the indicator at a second state indicating a transition of the mobile station to an idle state upon call release.

25. The base station of claim 24, wherein the message comprises a broadcast message.

26. The base station of claim 24, wherein the controller is adapted to further transmit, in the message, call control information for the mobile station to use in the idle state, the call control information including one or more of the following: carrier frequency information, CDMA band class, indication to return to one of a paging channel and broadcast control channel, a paging channel number, a paging channel data rate, a broadcast control channel Walsh code, a broadcast control channel data rate, and a broadcast control channel code rate.

27. The base station of claim 24, wherein the controller is adapted to select one of the first state and second state for the indicator.

28. The base station of claim 24, wherein the controller is adapted to periodically transmit the message containing the indicator to the mobile station.

29. The base station of claim 24, wherein the interface is adapted to communicate the message to the mobile station in one of a paging channel and a broadcast control channel.

30. The base station of claim 29, wherein the message comprises one of an Extended System Parameters Message and MC-RR Parameters Message according to IS-2000.
